(19) United States
(12) Patent Application Publication
(10) Pub. No.: US 2024/0341475 A1
(43) Pub. Date: Oct. 17, 2024

(54) COMPOSITE MATERIAL INCLUDING A THERMOPLASTIC POLYMER RESIN, A WOOD-LIKE THERMOPLASTIC ELASTOMER, AND A POLYESTER-BASED ADHESIVE

(71) Applicant: Wen Tang TSAI, Taichung City (TW)

(72) Inventor: Wen Tang TSAI, Taichung City (TW)

(21) Appl. No.: 18/631,854

(22) Filed: Apr. 10, 2024

Related U.S. Application Data
(60) Provisional application No. 63/458,503, filed on Apr. 11, 2023.

(51) Int. Cl. A47B 96/20; B32B 3/04; B32B 5/18; B32B 27/06; B32B 27/08; C08L 67/02

(52) U.S. Cl. CPC A47B 96/206; B32B 3/04; B32B 5/18; B32B 27/065; B32B 27/08; C08L 67/02; B32B 2266/0264; B32B 2307/558; B32B 2307/584; B32B 2307/726; B32B 2479/00; C08L 2207/20

(57) ABSTRACT

A wood substitute material is disclosed that is made from recycled polyethylene terephthalate (PET) which itself is covered or encased in a CELLWOOD or wood or plastic veneer. The wood substitute material is a durable, eco-friendly, and cost-effective alternative to wood. Additionally, the wood substitute material is distinguishable in that it has insulating properties. Constructed thermoplastic polymer layers may be combined to be used in various applications such as furniture, cabinetry, shelving, countertops, construction, sheathing, roofing, flooring, and as a substitute for wood in other wood-based products.

### CROSS REFERENCE TO RELATED APPLICATIONS

This application claims priority under 35 U.S.C. § 119 to U.S. provisional application Ser. No. 63/458,503, filed on Apr. 11, 2023, the entire contents of which are incorporated herein by reference.

### BACKGROUND

### Field

The present invention relates to compositions and constructions of one or more composite organic materials that are sturdy, water-resistant, weather resistant, and can be used as an effective insulation material.

Wood has been a construction staple for both indoor and outdoor fabrications throughout history. Because of its durability, longevity, strength, rigidity, and ease with which it can be cut and shaped into a variety of configurations and sizes; wood is an ideal building material. Wood can be cut into dimensioned lumber, for example, two-by-fours, one-by-tens, plywood, trim board, and the like, furthermore different pieces of lumber can be easily attached with glue, nails, screws, bolts, and other fastening means.

Natural wood is a versatile product that has extensive applications such as fence construction, building construction, shed construction, decking material, flooring material, indoor/outdoor furniture, etc. For example, woods such as oak, maple, and pine have traditionally been used for indoor cabinetry, flooring material, and furniture products. Wood with particular resistance to weathering, for example, cedar and teak are suitable for patio furniture, for both indoor and outdoor use.

While trees are a renewable resource, the current demand for wood and other tree products is causing deforestation at a rate higher than trees can reproduce. Additionally, the shortage of trees contributes to global warming, as there are fewer trees to absorb the excess carbon dioxide. Due to concerns of deforestation, global warming, and other environmental issues relating to the shortage of trees, there is an ongoing attempt to create wood substitutes from materials such as plastics and concrete. While plastics have some favorable properties such as moldability and high tensile strength, traditional plastic wood replacements, for example, Trex decking, generally have a lower bending strength than hardwood, a lower creep performance than wood, and a linear thermal expansion coefficient larger than wood. Concrete, on the other hand, is a potential wood substitute due to its extremely high compressive strength and flexural modulus. Yet, it is still a subpar replacement because it is brittle, with low toughness and low deflection properties.

Other polymer-based replacements, such as “CELLWOOD” offer an eco-friendly alternative to natural wood. CELLWOOD consists of thermoplastic elastomers, without relying on any wood flour or wood dust fillers. CELLWOOD provides the benefits of plastics such as water resistance, moldability, and high tensile strength, while also supplying the durability, longevity, strength, rigidity, insulation properties, and machinability of natural wood.

Furthermore, it boasts a coefficient of thermal expansion closer to that of natural wood. Still, CELLWOOD is not recommended for use as a main construction material, nor does it offer acceptable insulation properties. Additionally, the cost of CELLWOOD products is currently approximately 25% less than installations with real wood, per square foot. While CELLWOOD is more cost-effective, it is still not significantly cheaper than wood. Therefore, a more affordable alternative, boasting a broader range of applications while still providing the benefits of CELLWOOD is necessary. Presently described in this application is an affordable alternative to CELLWOOD, while also providing an avenue to recycle the plastic waste that currently pollutes landfills and chokes oceans, lakes, and rivers. 8.3 billion metric tons of plastic have been produced since plastics were introduced in the 1950s, but only 9% of plastics end up recycled. Additionally, when plastics pollute landfills, they release toxic chemicals, contaminate the soil and waterways, and enter the food chain. The present invention described in this application presents a novel method for coating a recycled plastic filling with a CELLWOOD veneer to create an eco-friendly wood alternative that reuses existing plastics rather than allowing them to continue polluting the environment.

In addition to recycling excess plastics, eco-friendliness is also beneficial and some embodiments of the present invention disclose a thermal insulator, promoting energy efficiency when used as building siding, roofing, or other construction material. Generally, buildings are constructed with decorative siding, such as CELLWOOD, for visual appeal, a house is wrapped to prevent moisture and water from damaging the wood, and insulation is provided to shield the inside of the building from the outdoor temperatures. Generally, insulation is either placed between studs or along the interior of the building, detracting from valuable square footage. Thus, also disclosed herein is an alternative to traditional insulation methods. Rather than insulating a building from within, systems disclosed herein can be used to insulate, waterproof, and decorate a building from the outside in a single, easy-to-work-with, light, affordable layer. Offering maximum insulation, without compromising square footage, and eliminating the need for separate siding, house wrap, and insulation.

### SUMMARY

Disclosed is a synthetic building material that simulates a wood product. Yet, due to its synthetic nature, the product is suitable for use in harsh environments (i.e., high heat and/or moisture) such as the kitchen, bathroom, and outdoors in the sun, rain, and snow.

The material can be formed by encasing many recycled plastic materials, which can then easily be fabricated into various shapes such as elongated boards, as well as other geometric shapes such as oval, polygonal, circular, and the like, held within a “CELLWOOD”, or other similar veneers. The final product may incorporate reinforcement elements such as long fiber reinforcements to enhance its mechanical strength. In some embodiments, to decrease the weight of the materials, a blowing agent is blended with the plastic material during the recycling process. In some embodiments the recycled plastic material assumes the form of a smooth foam at the end of the recycling process, augmenting the product's insulation properties.

In some embodiments, the veneer may be entirely in the form of a thin film wrapped around the recycled plastic material. In other embodiments, individual sheets of the veneer can adhere to each respective side of the recycled plastic assembly. The veneer may be attached to the recycled plastic material in a variety of ways, including but not limited to epoxy resin and polyester adhesives. Additionally, in some embodiments, single-layer veneer sheets are layered on top of each other to create a thicker product. The veneer sheets can be attached using heat compression or with glue containing toluene solvents.

In one embodiment material may be used to fabricate cabinets including, but not limited to, partial overlay, full overlay, and inset cabinets. Such fabrications have the advantage of being strong enough to support hundreds of pounds while being lightweight enough for easy self-installation. Additionally, the durable, scratch resistant, and waterproof, material that is created is ideal for use in wet, highly humid, and messy spaces such as kitchens and bathrooms. Due to its strength and the ease with which it can be installed, systems disclosed may also be assembled into shelving, including but not limited to shelving in constantly damp, moist locations such as in showers, under sinks, outdoors, and in bathrooms and kitchens. Supporting shelves may include solid material, with conglomerate recycled plastic core, and may include a solid veneer on the top and bottom. An optional laminate or veneer may be applied to one or more perimeter edges. The structural walls and top/bottom are preferably made from a foamed panel that may include a veneer on one side, and a laminate on the exterior side(s), or laminate on both sides. Edges of structural boards may also be improved/aesthetically and presented with formed profiles. A face or face plates (and doors) may be made of a complete solid material, and/or may also include a conglomerate core. Wood veneer is preferably applied to the face (door skin for example) surfaces. Doors are preferably one sold material, that may include veneer or laminate. Paint may be applied to one or all surfaces. One or more sections may be made with wood framing or other known stiffening and/or structural materials.

In another embodiment, material may be used to produce skateboard decks with a controlled flex system. Such fabrications are ideal because the final product is lightweight, structurally strong, fire-resistant, and UV-inhibited. Additionally, the product is stiff enough to avoid damage, yet flexible enough to absorb impact. The product holds its shape well, producing a satisfactory skateboard “pop”. A single solid layer may be used, or more preferably a multiple, two, three, five, or up to fourteen layers may be presented. Each layer may be comprised of a different material, but preferably a solid material is used for most/all pieces/layers. The layers may be of different thickness, with a central conglomerate panel may be thicker than other layers. One or more adhesives may be used between the layers such as to provide more flexibility, pop (resilient spring), or sturdiness.

A further embodiment of the present invention is construction material. Material may replace plywood or particle board for structural framing, and other construction uses. The disclosed material is particularly suited as a plywood replacement due to its strength, thickness, durability, water resistance, and rigidity. Material may also function as a replacement for a variety of construction needs including, but not limited to, nonstructural studs, doors, baseboards, deck and railing systems, and baseboards due to its water-resistant, strong, scratch-resistant nature. Panels may be of one or more materials structures. Preferably, recycled conglomerate materials form one or more layers of a single board. The disclosed material may also function as an outdoor lumber replacement. Such material is uniquely suited for use as decorative outdoor sheathing lumber due to its waterproof, weather-resistant, heat and cold-resistant nature. Because the material can be fabricated in any color, it does not need to be painted. Additionally, its insulation properties allow it to be used as both an insulator and decorative outdoor sheathing, removing the need for traditional insulation and moisture resistant house wraps. Furthermore, because of the various coating options the material may also serve as roofing material including, but not limited to, roof shingles, roof tiles, or roof sheets coated with mylar or other such materials to function as both roofing and solar panels.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a cross-section view of an embodiment of the present invention illustrating the smooth foam recycled filling encased in a wood-like veneer.

FIG. 2 illustrates an embodiment of a cabinet used with the present materials.

FIG. 3 shows a side view of two embodiments of the recycled filling in accord with the present disclosure.

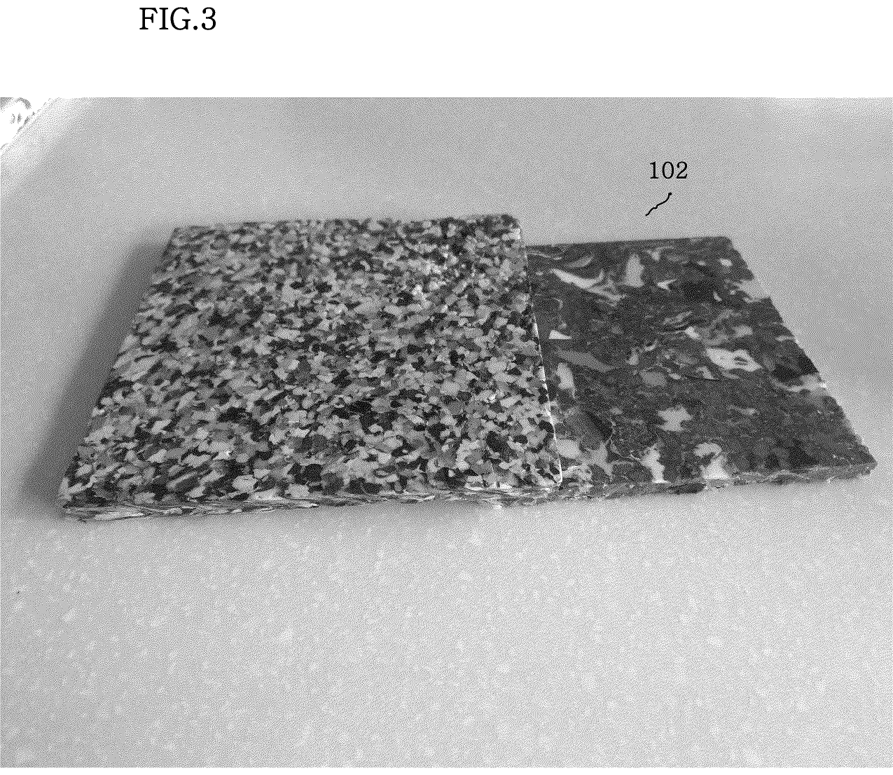

FIG. 4 shows and end view of the two embodiments shown in FIG. 3.

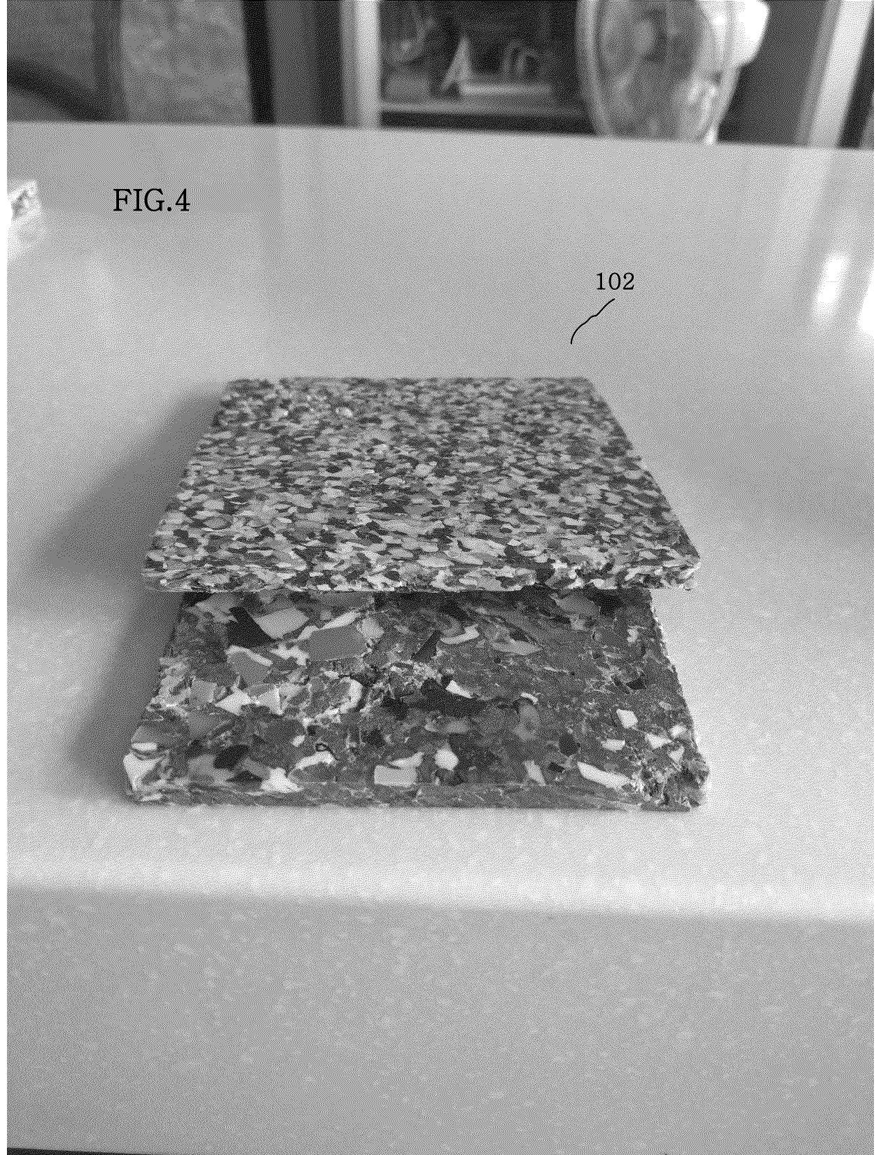

FIG. 5 shows a top of an embodiment of the present invention with a wood finish.

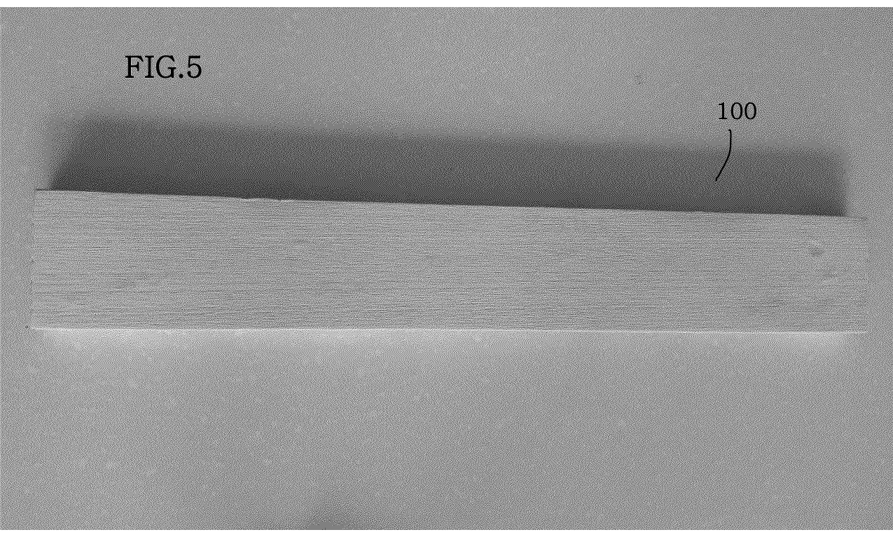

FIG. 6 shows a top perspective side view of the embodiment show in FIG. 5.

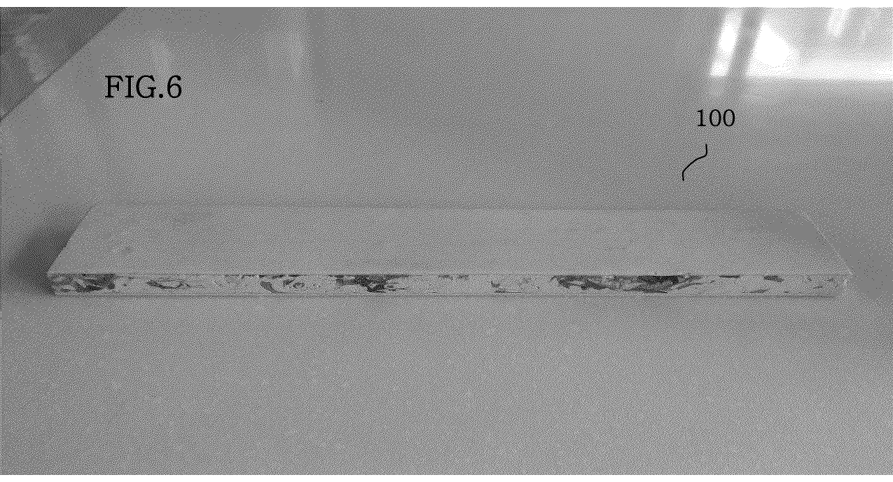

FIG. 7 shows a side view of the embodiment show in FIG. 6.

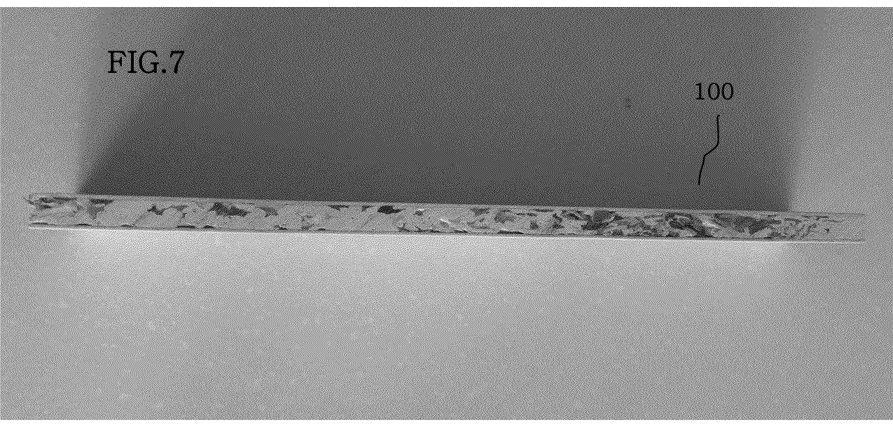

### DETAILED DESCRIPTION OF EXAMPLE EMBODIMENTS

### General Components

In describing the preferred embodiments of the invention, specific terminology will be used for the sake of clarity. However, the invention is not intended to be limited to the specific terms so selected, and it is to be understood that each specific term includes all technical equivalents that operate similarly to accomplish a similar purpose.

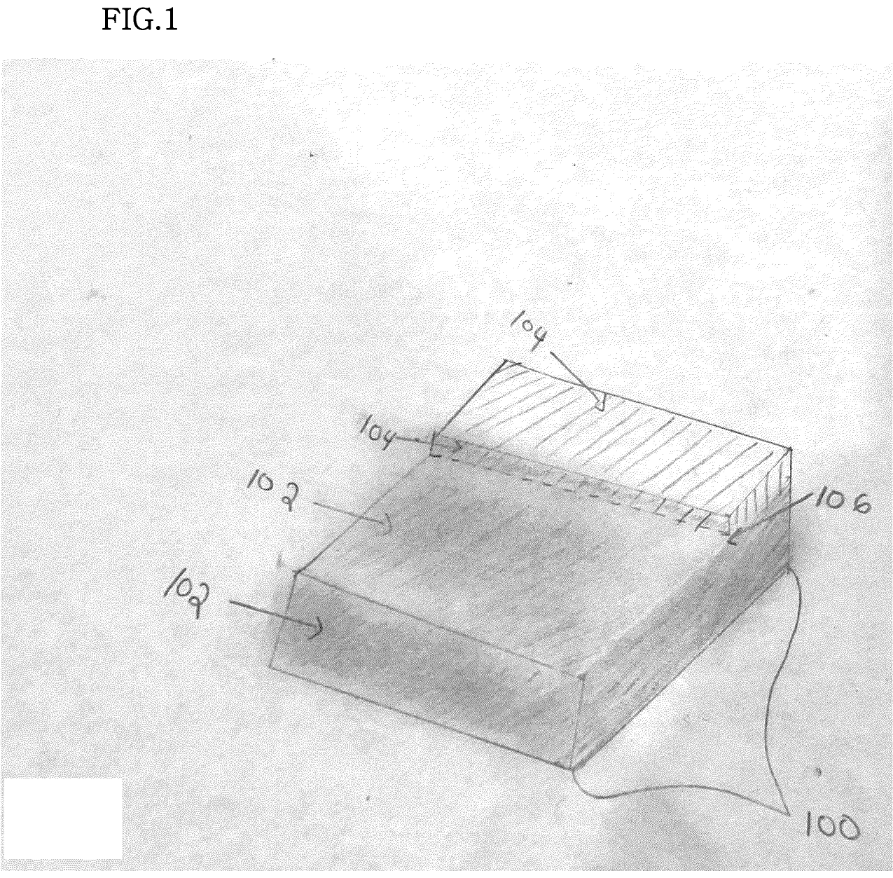

Referring to the drawings, especially FIGS., 1, and 3-7, wherein like reference numerals represent like elements, there is shown in FIG. 1 a section of an elongated board or plank constructed in accordance with one embodiment of the present invention, and designated generally as reference numeral 100. The board 100 is comprised of an inner recycled plastic filling 102 with the recycled plastic filling encased in a wood-like veneer 104. In some embodiments, the recycled plastic filling 102 is a smooth foam. The recycled plastic and/or smooth foam filling 102 possesses suitable characteristics for its intended use. Such characteristics include but are not limited to its strength, rigidity, water resistance, low thermal conductivity, weightlessness, and minimal thermal expansion. Plastic materials and mixtures thereof which possess suitable characteristics for useful materials include but are not limited to polyethylene terephthalate (PET), polyethylene (PE), polypropylene (PP), and polyvinyl chloride (PVC). The preferred material is PET.

The recycled plastic smooth foam 102 can be made using the following traditional extrusion techniques. Foam is preferably comprised of a density of approximately 3.5 to 22 lbs per cubic foot, with bubble sizes suitable to use and preferably uniform or within 300% size relative one to another. Cleaned PET is first shredded into small flakes. The small flakes are then melted and extruded through a die to form a continuous sheet of a specific thickness between 3 mm to 5 cm. The extruded sheet is expanded into a foam using a blowing agent including, but not limited to, pentane, carbon dioxide, nitrogen, hydrocarbon, ketones, or alcohol. The expanded foam is cooled, preferably by passing the foam through a water bath until its shape and structure are set. Once the foam is properly cooled, the foam is cut into the desired shape and size using a specialized plastic cutting machine. It is also contemplated that thermoset polymer materials may be used for creating objects that can be molded into predetermined shapes. Thus, it should be understood that a wide variety of synthetic polymer materials may be used in constructing the materials.

The wood-like veneer is preferably comprised of materials sold under the mark and term CELLWOOD but may also include natural wood, particle board, and wood-plastic composite materials (like Trex) or laminates. CELLWOOD is a thermoplastic elastomer product that is non-toxic, heavy metal free, and formaldehyde free. It has wood like properties, is particularly scratch-proof and dent resistant, and is recyclable and reusable. By coating the recycled PET foam with CELLWOOD the strength, affordability, and insulation properties of the foam are complemented by the beautiful properties of CELLWOOD.

### Recycled PET Making Process

The following processes are illustrative in nature and are not intended to limit the process of producing PET foam in any way.

After the recycled PET containers are chopped into flakes, the pure PET flakes must be separated from flakes containing impurities, and from other debris mixed into the flakes. In some embodiments, the recycled PET is derived from post-consumer containers. Sometimes, bales of clear and mixed-colored recycled post-consumer PET containers obtained from various recycling facilities make up the post-consumer PET containers for use in the process. In other embodiments, the PET bottles and containers are collected through “curbside” recycling pickup programs.

Sometimes, the source of the post-consumer PET containers may be returned ‘deposit’ bottles. The curbside or returned “deposit” bottles may contain a small level of non-PET contaminants. The contaminants in the containers may include but are not limited to, non-PET polymeric contaminants such as PVC, PLA, PP, PE, PS, PA, etc. The contaminants may also include, but are not limited to, ferrous and non-ferrous metal, paper, cardboard, sand, glass, or other materials that may find their way into recycling bins. The non-PET contaminants may be removed from the desired PET components through various processes including but not limited to one or more of the processes described below.

One process for removing contaminants involves removing smaller components and debris from the whole bottles via a rotating trammel. Various metal removal magnets and eddy current systems may be incorporated into the rotating trammel to remove any metal contaminants. Near Infra-Red optical sorting equipment such as the NRT Multi Sort IR machine or the Spyder IR machine may also be utilized to remove any loose polymeric contaminants that may be mixed in with the PET flakes. Additionally, automated X-ray sorting equipment may be utilized to further remove remaining PVC contaminants.

Once the PET flakes are properly separated from impurities, the flakes are washed by a series of wash tanks. In some embodiments, the wash tanks are also used to clean olefin bottle cap residue from the PET flakes because PET has a higher specific gravity than the olefin bottle caps. In some embodiments, the flakes are washed in a caustic bath and heated to about 190 degrees Fahrenheit. The caustic bath may be maintained at a concentration of between about 0.6% to about 1.2% sodium hydroxide. In some embodiments, soap surfactants, as well as defoaming agents, are added to the caustic bath, for example, to further increase the separation and cleaning of the flakes. A double rinse system then washes the caustic solution from the flakes.

To dry the flakes, a centrifuge is first used to remove the water. The flake is then dried with hot air to remove any surface moisture. The resultant “clean flakes” are then processed through an electrostatic separation system and a flake metal detection system to remove any remaining metal contaminants that remain on the flakes. Sometimes, an air separation step may be used to remove the remaining labels from the clean flake. Additionally, an electro-optical flake sorter may perform the final polymer separation to remove any non-PET polymers or metal contaminants that persist.

The combination of these steps delivers substantially clean PET bottle flakes comprising less than approximately 50 parts per million PVC and less than approximately 15 parts per million metals for use in the extrusion process.

Sometimes, after the flakes are washed, they are fed down a conveyor and scanned with a high-speed laser system. Such laser systems include but are not limited to lasers configured to detect contaminants such as PVC and aluminum. Flakes that are identified as containing remaining contaminants may be blown from the stream of flakes with air jets. In some embodiments, the resulting level of non-PET flakes is less than 25 ppm.

In some embodiments, it is preferable that the flakes are substantially free of water. In such embodiments, the flakes may be placed in a system where the flakes are blown with air for 20 to 40 minutes, but preferably 30 minutes. Thus, any remaining surface water is removed from the flakes. In other embodiments, the aforementioned water-removing step can be skipped, and the wet flakes may be fed directly into the extruder.

An extruder may be used to convert the flakes into the PET foam filling. When performing extrusion, the flakes are heated and pushed through a die, molding the melted flakes into the desired shaped foam.

In some embodiments, an extruder is used to turn the wet flakes described above into a molten recycled PET polymer and to perform several purification processes to prepare the polymer to be turned into smooth foam. In particular embodiments, these wet flakes are fed into a Multiple Rotating Screw (“MRS”) extruder. In other embodiments, the wet flakes are fed into any other suitable extruder, including but not limited to, a twin screw extruder, a multiple screw extruder, a planetary extruder, or any other suitable extrusion system. A particular example of such an MRS extruder is described in the U.S. Published Patent Application 2005/0047267, entitled “Extruder for Producing Molten Plastic Materials”, which was published on Mar. 3, 2005, and which is hereby incorporated herein by reference.

The wet flakes may be fed directly into the extruder immediately following washing, so long as the extruder includes a vacuum component during the melting step. Feeding the wet flakes directly into the Extruder immediately following washing may consume approximately 20% less energy than a system that pre-dries the flakes before extrusion. Additionally, feeding the flakes into the extruder while they are wet saves approximately eight hours, as it takes approximately eight hours for the flakes to fully dry.

When using an extruder, the flakes are first fed into the extruder and subsequently melted using heat and mechanical shearing. For PET the preferred melting temperature is 206 degrees Celsius. The flakes are fed into the feed barrel from a hopper. If reinforcing fibers are to be incorporated to the final product, the fibers may be added to the feed barrel at this point as well.

The reinforcing fibers may be added in the form of chopped fibers, continuous fibers, or woven fabrics. As the flakes are fed into the feed barrel, a screw or multiple screws within the feed barrel drive the flakes forward while rotating them. The flakes melt as they are driven forward by the screws, both due to the frictional heat created when the plastic molecules slide over each other and due to external feeding bands. Once the melted material reaches its final temperature it is then fed through a die for shaping into its desired form.

A preferred extrusion method is profile extrusion, wherein the melted material is fed through a die into a cooling trough filled with cold water. The product solidifies and cools in the water. At the end of the cooling trough, a haul-off pulls the product away from the die at a uniform, controlled, speed. The product is then cut to its desired size by a shearer. The resulting product is an embodiment of a suitable filling or inner layer of the final product.

### Producing a Recycled PET Smooth Foam

To increase the insulation properties, and to decrease the weight of the final product, PET can also be recycled into foam boards. The process for extruding PET into foam boards is similar to the plastic recycling process detailed above. Basic foam extrusion is comprised of mixing a chemical foaming agent with the polymer, preferably PET flakes, to be extruded. The heat generated to melt the polymer decomposes the chemical foaming agent resulting in a release of gas from the chemical foaming agent. This gas is dispersed throughout the polymer melt and expands upon exiting the die.

Most common extruders can be used to produce smooth foam, so long as the melt temperature is high enough to guarantee a complete decomposition of the foaming agent and the pressure of the melt is high enough to keep the gas dissolved in the polymer melt until the melt exits the extrusion die. To ensure that the gas does not escape from the extruder, the vent opening may be sealed. If the melt temperature is too low, the decomposition of the foaming agent will be incomplete, resulting in waste. Additionally, un-decomposed foaming agent particles can lead to agglomerates, which can clog the melt filter, cause voids, poor cell structure, or poor surface appearance in the final product. Furthermore, low pressure can lead to “prefoaming”. If pressure is subsequently increased to remedy low pressure, the gas cannot be “re-dissolved”, and the final product will include a large irregular cell structure with broken and collapsed cells. If properly extruded, the final smooth foam product may function as a superior alternative to wood, as it offers superior insulation properties, with boards that are 6 inches thick providing an R-value of 30. The product is a satisfactory wood replacement; for example, its wood replacement capabilities include, but are not limited to, use as material for cabinets, shelving, indoor and outdoor construction, skateboards, doors, exterior trim, plywood, roof tiles, and solar panels. The product is a particularly satisfactory wood replacement because it is lightweight, has a tensile strength of 305 psi, a tensile modulus of 10.9 ksi (kilopound per square inch), a compressive strength of 139 psi, a compressive modulus of 8.27 ksi, a shear strength of 79.8 psi, and a shear modulus of 2.18 ksi. Furthermore, the product is compatible with traditional wood machining tools.

### Covering the Recycled Plastic With a Wood-like Veneer

Once the recycled product cools, it may be encapsulated in a wood-like veneer 104. A preferred veneer is CELLWOOD. The final product is peel-proof, waterproof, and will not be damaged by the sun or harsh weather conditions. The materials tend to have minimal thermal-expansion and may have very similar coefficients of expansion as neighboring layers. By laminating the CELLWOOD veneer 104 to the recycled plastic filling 102 with glue 106 including, but not limited to, polyester series adhesives or epoxy resin the two materials fuse seamlessly and are virtually inseparable.

Additionally, for increased flexibility, multiple single sheets of veneer may be layered over recycled plastic filling 102. The veneer sheets may be attached via heat compression or with a toluene solvent-based glue.

In some embodiments, each face of the recycled plastic product is separately covered by a veneer. Each face may be individually covered with glue, preferably polyester series adhesives or epoxy resin, and then subsequently laminated by a sheet of veneer. In other embodiments, the veneer may be thin film wrapped around the entire plastic product. The process of thin film wrapping the veneer involves wrapping a thin layer of the veneer around a plurality of faces. The veneer is preferably heated to its softening point to increase malleability. CELLWOOD, for example, should be heated to approximately 90 degrees Celsius. After the veneer is heated the glue 106, preferably either polyester series adhesives or epoxy resin, may be applied to the recycled plastic product. The softened veneer is then wrapped around the plastic product, over a plurality of sides. Given the tensile strength, compressive strength, and shear strength of the recycled plastic filling, once the plastic is encased in a wood-like veneer it may function as a suitable wood replacement. Once the veneer cools, the product may function as a suitable wood replacement. Some examples of the product's uses include, but are not limited to cabinets, countertops, skateboard decks, plywood for structural framing, shower trays and other fixtures used in wet and moist environments, doors, roof tiles, solar panels, exterior building trims, deck, and railing system, 3 in 1 decorative thermal insulation, baseboards, and indoor and outdoor construction material including, but not limited to non-loadbearing studs.

CELLWOOD is particularly advantageous because it is impact resistant, and has a compressive strength twenty times greater than the PET foam filling 102. It, therefore, provides the board with impact, and scratch-resistant properties.

### Cabinets

The disclosed material is preferably strong and durable, yet approximately 50% lighter than natural wood. Furthermore, the CELLWOOD veneer provides an impact-resistant coating, preventing dents, scratches, and damage to the material. It, therefore, is ideal for cabinet fabrication, particularly because it can be installed with traditional cabinet installation tools including, but not limited to, a saw, clamps, a drill, and a nail gun. Additionally, due to their weight, the cabinets can be easily installed by novices, such as users and homeowners, rather than by professionals. Material disclosed is particularly useful for use in wall-mounted cabinets because its lightweight yet sturdy properties make it ideal for wall installation without relying on the floor, or other under-mounted supports. Material may also be ideal for use in fabricating floor-mounted cabinets and base cabinets, which sit under sinks because the material is water-resistant and will not deteriorate when wet. While such cabinets may be fashioned and installed with traditional means known to those having ordinary skill in the art, cabinets bearing a CELLWOOD veneer can be laminated to each other using a toluene solvent-based glue or via heat compression, at temperatures above 90 degrees Celsius.

### Fashioning a Cabinet Box

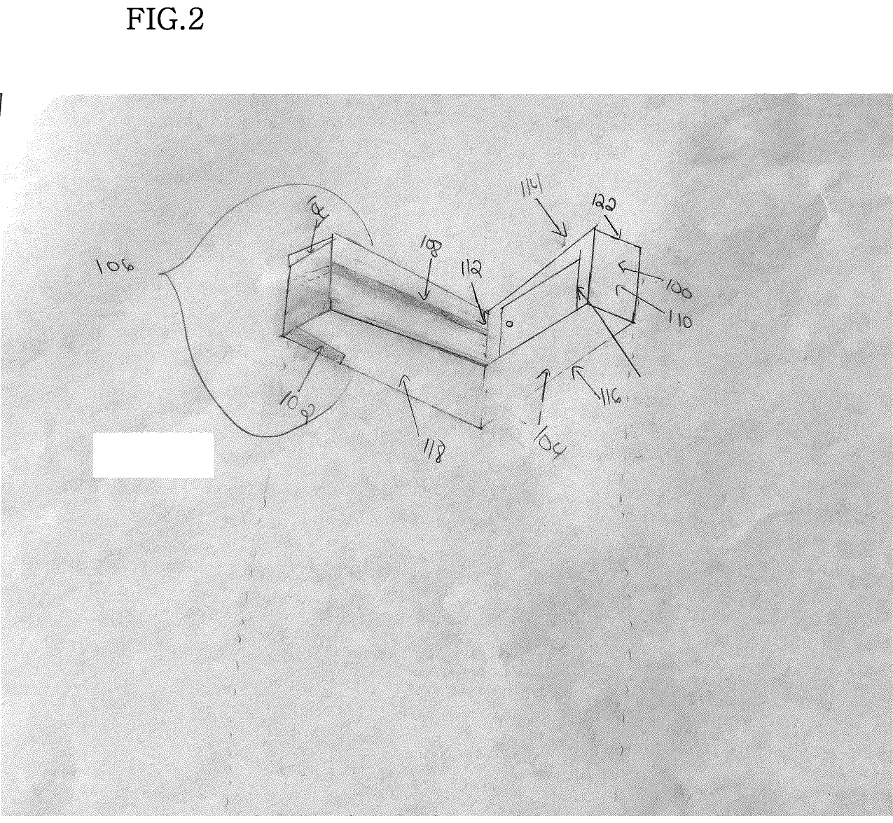

The following process is illustrative in nature and not intended to limit the process of producing cabinets fashioned from the materials produced and disclosed herein. Referring to the drawings, wherein like reference numerals represent like elements, there is shown in FIG. 2 an isometric view of a series of cabinets constructed in accordance with the materials presented in this disclosure. Plastic sheets coated with a wood like veneer 100, can be fashioned into lightweight, yet sturdy cabinet boxes 106 containing load. Load-bearing shelves 108 comprised of the same material.

A cabinet box 106, also called the cabinet case, is the foundation of any cabinet. The box shape is comprised of two side panels 110 and 112, a top panel 114, a bottom panel 116, and a back panel 118. While the panels are traditionally comprised of wood or particle board, thermoplastic material may be a superior material for cabinet box fabrication. The panels of the cabinet box are traditionally fastened to each other with joinery. Depending on the type of joinery used the cabinet box may have exposed or mitered edges.

While cabinet boxes fashioned from the thermoplastics material(s) may use traditional wood fastening materials, such as but not limited to, joinery, they can also be laminated to each other using a toluene solvent-based glue 122, or via heat compression at temperatures exceeding 90 degrees Celsius. Doors can be mounted to the cabinet box using standard hinges 124 including but not limited to, full and partial wraparound hinges, flush mount hinges, inset hinges, surface mount hinges, semi-concealed hinges, T-style hinges, butt hinges, soft close hinges, self-open hinges, self-close hinges, and full or partial overlay European hinges.

To build a cabinet box, five separate rectangular pieces are attached. Parallel top 114 and bottom 116 pieces cut to the same size are connected by two parallel side pieces 110 and 112 cut to the same size as each other, but not necessarily the same size as the top and bottom pieces. The side pieces' width should mirror the length of the top and bottom pieces. A back piece 118 having the same length dimensions as the side pieces and the same width dimensions as the top and bottom pieces is attached with its bottom being attached to the bottom piece and its sides being attached to the side pieces. The separate pieces may be attached with traditional joiners, laminated to each other with a toluene solvent-based glue, or attached via heat compression at temperatures exceeding 90 degrees Celsius. Sample dimensions for a standard cabinet box include but are not limited to, top and bottom pieces having a length of 14 inches and a width of 24 inches, side pieces having a length of 30 inches and a width of 14 inches, and a back piece having a length of 30 inches and a width of 24 inches.

When preparing the panels for attachment, proper safety precautions should be taken, including, but not limited to, wearing glasses and earplugs while using the saw, using a system for collecting sawdust, and ensuring that the table saw blade is square with the table. Because the veneer may be produced with a wood grain finish, for a continuous wood grain look, the side panels and back piece should be cut with a vertical grain running parallel to the length, and the top and bottom pieces should be cut with a horizontal wood grain running perpendicular to the length.

The panels may first be cut, for example with a saw, by making a rip cut. Each panel may be cut to its desired width or length, in a direction parallel to the wood grain. After the rip cuts are complete, the crosscuts may be cut against the grain. If one chooses to use joinery rather than lamination, cuts may be fashioned into the panels for joinery using a CNC machine, a table saw, and/or a series of dowels or dominoes. In other embodiments, the panels may be laminated one to another without the need for joiners. Rather, a toluene-based solvent or heat compression, as described above may be used.

### Shelving

Referring to the drawings, wherein like reference numerals represent like elements, there is shown in FIG. 2, shelving 108, within a cabinet. The shelving may be comprised of a recycled plastic filling coated in a wood like veneer. In some embodiments, the recycled plastic filling is a plastic foam. A plastic foam filling is advantageous in that it is lighter than a solid plastic filling, and therefore easier for users to install themselves. Additionally, plastic foams have a high specific strength. In other embodiments, the shelving may be comprised of layers of a wood like, thermoplastic elastomer laminated to each other with a toluene solvent-based glue, or attached via heat compression at temperatures exceeding 90 degrees Celsius, without the need for a plastic filling.

Such shelving may function as fixed shelving 108, within a cabinet, or as floating shelves. Because the material is water resistant it is particularly useful in moist places such as bathrooms and kitchens. In other embodiments, it can be used as shelving in pantries, closets, and other storage facilities. Furthermore, because the material is weather resistant and not damaged by UV light, it may serve as shelving in outdoor patios, pools, and backyards.

### Skateboard Decks

In another embodiment, thermoplastic polymer material may be used to produce skateboard decks with a controlled flex system. Such fabrications are ideal because the final product is lightweight, structurally strong, fire-resistant, and UV-inhibited. Additionally, the product is stiff enough to avoid damage, yet flexible enough to absorb impact. The product holds its shape well, producing a satisfactory skateboard “pop”.

In some embodiments, skateboard decks may be produced by sandwiching 8 mm of recycled plastic material 102 between CELLWOOD veneers, preferably the two sets of CELLWOOD veneers should be 3 plies each.

Each layer of CELLWOOD may be approximately 1/17th of an inch thick. Additionally, the CELLWOOD should be approximately 8 inches wide and 31 inches long. The material may be cut using a jigsaw or bandsaw.

The CELLWOOD veneers 104 may be laminated to each other with glue containing a toluene solvent or by heat compression at temperatures above 90 degrees Celsius. When using glue to laminate the layers, a thin layer of glue may be applied to the entire top of one veneer and to the entire bottom portion of a second veneer. The two pieces may then be pushed together so that the glue-coated faces make contact. Repeat the process by applying glue to the bottom face of the attached veneers and to the top face of a single veneer. It is preferable that glue is evenly spread on both faces in preparation for attachment.

Once the veneers are laminated, each 3-ply product may be attached to the 8 mm plastic material using epoxy resins or polyester series adhesives. In some embodiments, the 3 ply veneers may be a mixture of CELLWOOD and other materials, including but not limited to maple wood. In other embodiments, the entire deck may be comprised of 7 plies of CELLWOOD, each layer being 1/17th of an inch thick, eliminating the need for a plastic core.

Once the layers are laminated to each other, attach clamps around the layers to press them together while the glue dries, generally for four to twenty-four hours. In other embodiments, the layers may be pressed with a hydraulic press for a minimum of four hours, but preferably for twenty-four hours. It is preferable that the deck cures in a room-temperature space with minimal humidity.

After the deck has cured or cooled, if using heat lamination, it may be cut to its desired shape. Because the deck is comprised of PET and thermoplastic rather than natural wood, it does not need to be sanded. Rather, after shaping the deck may be coated with grip tape, and is subsequently ready for use.

### Other Uses

Thermoplastic polymers may also be used as decorative siding may replace the need for house moisture wrap, siding, and insulation. Due to the waterproof nature of the material, the material may have an R-value of 30 when 6 inches thick, attaching it to the exterior of a building, in the same manner, that vinyl siding is attached, provides waterproofing, insulation, and decoration to the interior of a building.

Material can also function as roofing, as it can be shaped into roof tiles, simulated shingles, or roof sheets. Such roofing material can be coated in mylar, or other such material, to reflect the solar irradiance and prevent the interior of a building from solar heat. In other embodiments, the roofing material may be coated in solar cells, or other such energy-absorbing materials, to function as built-in solar panels.

Material may also replace particle board or plywood as a construction material, function as a baseboard or window trip, or replace traditional decking and railing. The above disclosure is exemplary in nature and not intended to limit the utility of the present invention in any way.

What is claimed is:

1. A composite material comprising:
a. a first inner layer comprising a thermoplastic polymer resin encased in a thermoplastic elastomer; and
b. at least a second inner layer comprising a second thermoplastic polymer resin encased in a second thermoplastic elastomer; wherein said first layer and said second layer are set adjacent to one another with an intermediate adhesive layer set therebetween.

2. The composite material set forth in claim 1 wherein the thermoplastic polymer resin further comprises air pockets.

3. The composite material set forth in claim 1 further comprising reinforcing fibers enmeshed in the thermoplastic polymer resin.

4. The composite material set forth in claim 1 wherein the thermoplastic polymer resin is recycled polyethylene terephthalate.

5. A cabinet comprising a multitude of panels, wherein each of said panels comprises a multi-layered thermoplastic polymer resin encased in a thermoplastic elastomer, said cabinet comprising
a. a side panel comprising a foamed thermoplastic polymer resin;
b. a face panel comprising a solid thermoplastic polymer layer; and
c. at least one shelf suspended between said side panel and a second side panel; wherein
said side panel comprises a veneer of thermoplastic elastomer.

6. The cabinet set forth in claim 5 wherein said side panel comprises air pockets.

7. The cabinet set forth in claim 5 wherein said side panels comprise reinforcing fibers.

8. The cabinet set forth in claim 5 wherein said side panel comprises a veneer of thermoplastic.

9. The cabinet set forth in claim 5 wherein said face comprises a solid thermoplastic polymer layer.

10. The cabinet set forth in claim 5 wherein said face panel comprises a three-dimensional artificial wood vein pattern.

11. A countertop for use with a sink and one or more items; said countertop comprising:
a. a thermoplastic polymer resin main panel comprises at least two layers;
b. one or more cut outs adaptable as one or more apertures to allow for a feature to be set through or thereon
c. a binding material set between said two layers;
d. wherein said one or more cut outs are set through said at least two layers.

12. The countertop of claim 11 wherein said at least two layers are bound by an adhesive.

13. The countertop of claim 12 wherein the layers and adhesive are exposed along an edge of the one or more cut outs.

14. The countertop of claim 11 further comprising a three-dimensional veneer applied over a top side.

15. The countertop of claim 11 wherein at least one of the at least two layers comprising a recycled conglomerate.

16. The countertop of claim 11 wherein at least one of the at least two layers comprising a foamed structure.
